(19) United States
(12) Patent Application Publication
(10) Pub. No.: US 2026/0212406 A1
(43) Pub. Date: Jul. 23, 2026

(54) INFORMATION PROCESSING APPARATUS, COMMUNICATION DEVICE, CONTROL METHOD THEREOF, AND STORAGE MEDIUM

(71) Applicant: HONDA MOTOR CO., LTD., Tokyo (JP)

(72) Inventors: Hiroaki UENO, Tokyo (JP); Kazumi OGAWA, Tokyo (JP)

(21) Appl. No.: 19/447,456

(22) Filed: Jan. 13, 2026

Related U.S. Application Data
(60) Provisional application No. 63/746,470, filed on Jan. 17, 2025.

(51) Int. Cl. G06Q 30/0645; G06Q 30/0283

(52) U.S. Cl. CPC G06Q 30/0645; G06Q 30/0283

(57) ABSTRACT

An information processing apparatus comprising: a holding unit configured to hold information on a lease usage fee of a first user who has a lease contract for a leased vehicle; a reception unit configured to receive information on a rent condition of a second user who is to have a sub-lease contract with the first user and rent the leased vehicle; a calculation unit configured to calculate a sub-lease usage fee of the leased vehicle based on the information on the lease usage fee and the information on the rent condition; and a determination unit configured to determine a reward to the first user based on the sub-lease usage fee.

### CROSS-REFERENCE TO RELATED APPLICATION(S)

This application claims priority to and the benefit of U.S. Provisional Patent Application No. 63/746,470 filed on Jan. 17, 2025, the entire disclosure of which is incorporated herein by reference.

### BACKGROUND OF THE INVENTION

### Field of the Invention

The present invention relates to an information processing apparatus, a communication device, a control method thereof, and a storage medium.

### Description of the Related Art

In these years, active efforts are being made to provide access to sustainable transportation systems in consideration of vulnerable people among traffic participants. In order to achieve this, research and development for further improving traffic safety and convenience are being focused on, through research and development of sharing. Forms of sharing include vehicle leases and sub-leases.

Japanese Patent Laid-Open No. 2021-96510 discloses that when a parked vehicle is leased in order to effectively utilize a space for automatic valet parking, a lease fee is discounted from a parking fee. Japanese Patent Laid-Open No. 2021-96510 further discloses that when a leased vehicle is sub-leased while the leased vehicle is parked, the sub-lease fee is discounted from the parking fee.

However, in the technique described in Japanese Patent Laid-Open No. 2021-96510, only a lease or a sub-lease of a parked vehicle in a specific parking lot is performed, and there is a problem that use of a leased vehicle is not widely and generally promoted.

### SUMMARY OF THE INVENTION

The present invention has been made in view of the above problem, and provides a technique for promoting use of a leased vehicle. In addition, accordingly, the present invention contributes to development of a sustainable transportation system.

According to one aspect of the present invention, there is provided an information processing apparatus comprising: a holding unit configured to hold information on a lease usage fee of a first user who has a lease contract for a leased vehicle; a reception unit configured to receive information on a rent condition of a second user who is to have a sub-lease contract with the first user and rent the leased vehicle; a calculation unit configured to calculate a sub-lease usage fee of the leased vehicle based on the information on the lease usage fee and the information on the rent condition; and a determination unit configured to determine a reward to the first user based on the sub-lease usage fee.

### BRIEF DESCRIPTION OF THE DRAWINGS

FIG. 1 is a diagram illustrating a configuration example of an information processing system according to an embodiment;

FIG. 2A is a diagram illustrating a hardware configuration example of a server device functioning as an information processing apparatus according to an embodiment;

FIG. 2B is a diagram illustrating a hardware configuration example of a communication device owned by a lease contractor according to an embodiment;

FIG. 3A is a diagram illustrating a hardware configuration example of a communication device owned by a sub-lease desiring person according to an embodiment;

FIG. 3B is a diagram illustrating a hardware configuration example of a leased vehicle according to an embodiment;

FIG. 4 is a diagram illustrating an example of a processing sequence performed in the information processing system according to an embodiment; and

FIG. 5 is a flowchart illustrating a procedure of processing performed by the information processing apparatus according to an embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

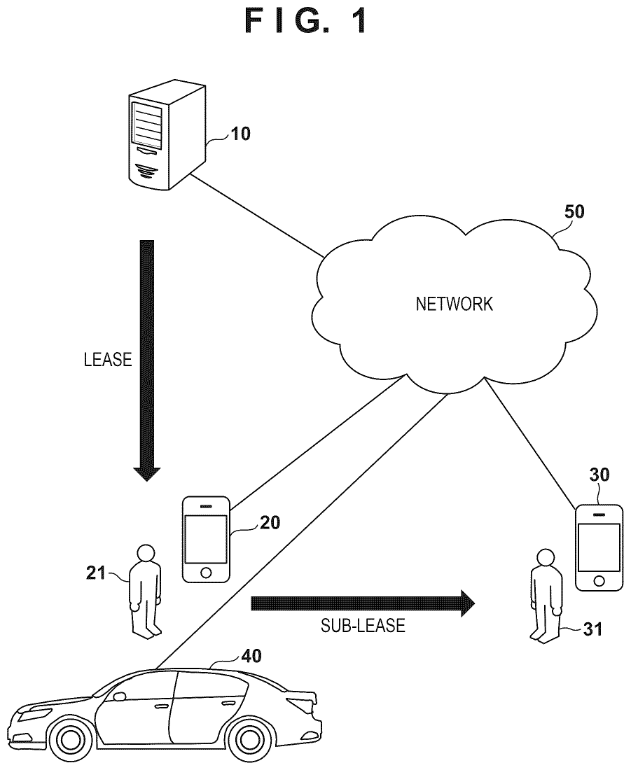

FIG. 1 is a diagram illustrating a configuration example of an information processing system according to the present embodiment. In FIG. 1, 10 denotes a server device (information processing apparatus) 10 that manages a lease contract of a leased vehicle 40 and a sub-lease contract of the leased vehicle 40. The server device 10 may be, for example, a server of a leasing company that provides the leased vehicle 40 to a user.

Reference numeral 20 denotes a communication device owned by a user 21. The communication device 20 is, for example, a smartphone, but may be another device such as a tablet terminal or a personal computer. The user 21 rents and uses the leased vehicle 40 from a leasing company according to a lease contract. The user 21 can rent a specific vehicle under a lease contract of X yen per month, for example.

Reference numeral 30 denotes a communication device owned by a user 31. The communication device 30 is, for example, a smartphone, but may be another device such as a tablet terminal or a personal computer. The user 31 enters into a sub-lease contract with the user 21, pays a sub-lease usage fee, and rents and uses the leased vehicle 40 used by the user 21 from the user 21.

Reference numeral 40 denotes a leased vehicle. The leased vehicle 40 is a vehicle that the user 21 rents by making a lease contract with a leasing company. The leased vehicle 40 is a four-wheeled vehicle in the illustrated example, but is not limited to a four-wheeled vehicle, and may be a two-wheeled vehicle, a three-wheeled vehicle, or the like.

Reference numeral 50 denotes a network. The server device 10 can communicate with the communication device 20, the communication device 30, and the leased vehicle 40 via a network 50 to transmit and receive various types of information.

The server device 10 manages the content of the lease contract of the leased vehicle 40 concluded between the user 21 and the leasing company. The server device 10 receives a request for a sub-lease contract of the leased vehicle 40 from the user 31, calculates a sub-lease usage fee, and pays a reward to the user 21 who has sub-leased the leased vehicle 40 to the user 31.

Since the user 21 can receive a reward by sub-leasing to the user 31, it is possible to reduce the lease usage fee. Therefore, since the burden of the usage fee of the leased vehicle 40 can be reduced, it is possible to encourage active use of the leased vehicle 40. As a result, a wide range of general users enter into a lease contract and use a leased vehicle, and the market of the leased vehicle can be expanded.

### Device Configuration

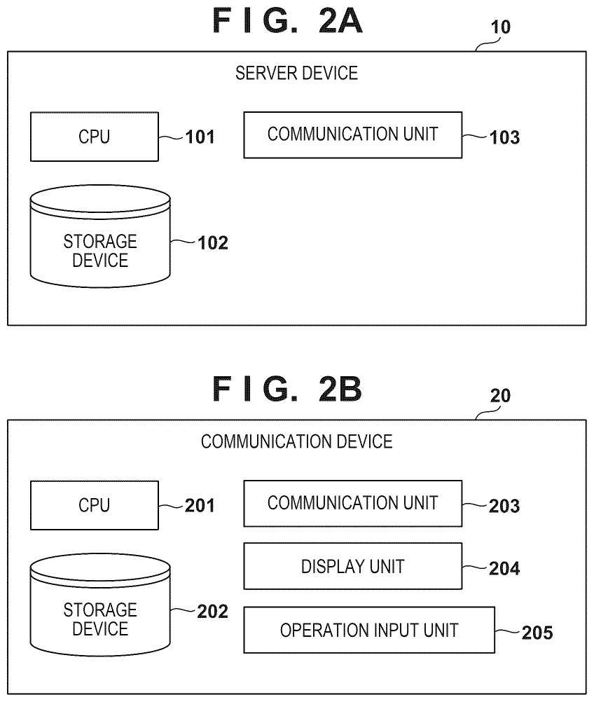

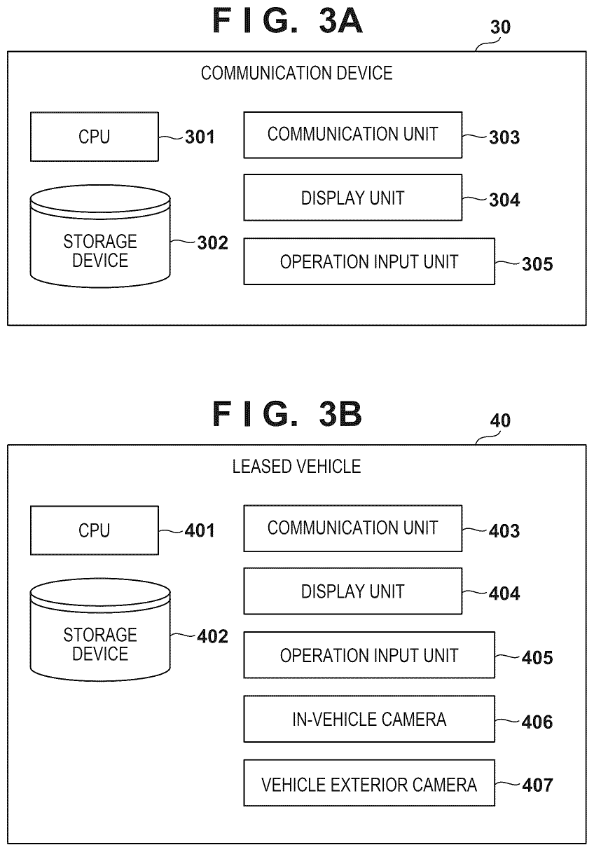

Next, configuration examples of the server device 10, the communication device 20, the communication device 30, and the leased vehicle 40 according to an embodiment of the present invention will be described with reference to FIGS. 2A, 2B, 3A, and 3B. FIG. 2A is a diagram illustrating a configuration example of the server device 10 functioning as an information processing apparatus according to an embodiment of the present invention. FIG. 2B is a diagram illustrating a configuration example of the communication device 20 according to an embodiment of the present invention. FIG. 3A is a diagram illustrating a configuration example of the communication device 30 according to an embodiment of the present invention. FIG. 3B is a diagram illustrating a configuration example of the leased vehicle 40 according to an embodiment of the present invention.

As illustrated in FIG. 2A, the server device 10 includes a CPU 101, a storage device 102, and a communication unit 103. A control operation of the server device 10 is achieved by the CPU 101 reading and executing a computer program stored in the storage device 102. The CPU 101 may be one or more CPUs. The storage device 102 is one or more memories that store several types of information. For example, information that has been received from another device, a computer program to be read and executed by the CPU 101, and the like are stored. The communication unit 103 has a function of communicating with another device in a wired or wireless manner through the network 50.

As illustrated in FIG. 2B, the communication device 20 includes a CPU 201, a storage device 202, a communication unit 203, a display unit 204, and an operation input unit 205. A control operation of the communication device 20 is achieved by the CPU 201 reading and executing a computer program stored in the storage device 202. The CPU 201 may be one or more CPUs. The storage device 202 is one or more memories that store several types of information. For example, information that has been received from another device, a computer program to be read and executed by the CPU 201, and the like are stored. The communication unit 203 has a function of communicating with another device in a wired or wireless manner through the network 50. The display unit 204 can include a liquid crystal display or the like, and displays various types of information. The operation input unit 205 can include a physical button, a virtual button on a touch panel, a keyboard, a mouse, and the like, and receives various operation inputs.

As illustrated in FIG. 3A, the communication device 30 includes a CPU 301, a storage device 302, a communication unit 303, a display unit 304, and an operation input unit 305. A control operation of the communication device 30 is achieved by the CPU 301 reading and executing a computer program stored in the storage device 302. The CPU 301 may be one or more CPUs. The storage device 302 is one or more memories that store several types of information. For example, information that has been received from another device, a computer program to be read and executed by the CPU 301, and the like are stored. The communication unit 303 has a function of communicating with another device in a wired or wireless manner through a network. 50 The display unit 304 can include a liquid crystal display or the like, and displays various types of information. The operation input unit 305 can include a physical button, a virtual button on a touch panel, a keyboard, a mouse, and the like, and receives various operation inputs.

As illustrated in FIG. 3B, the leased vehicle 40 includes a CPU 401, a storage device 402, a communication unit 403, a display unit 404, an operation input unit 405, an in-vehicle camera 406, and a vehicle exterior camera 407. A control operation of the leased vehicle 40 is achieved by the CPU 401 reading and executing a computer program stored in the storage device 402. The CPU 401 may be one or more CPUs. The storage device 402 is one or more memories that store various types of information. For example, information that has been received from another device, a computer program to be read and executed by the CPU 401, and the like are stored. The communication unit 403 has a function of communicating with another device in a wired or wireless manner through the network 50. The display unit 404 can include a liquid crystal display or the like, and displays various types of information. The display unit 404 may be a display unit of an in-vehicle car navigation system. The operation input unit 405 can include a physical button, a virtual button on a touch panel, and the like, and receives various operation inputs. The in-vehicle camera 406 captures an image of a driver's seat and captures and acquires an image of an occupant. The vehicle exterior camera 407 is a camera that captures an image of a surrounding environment outside the vehicle, and is, for example, a drive recorder.

### Processing Sequence

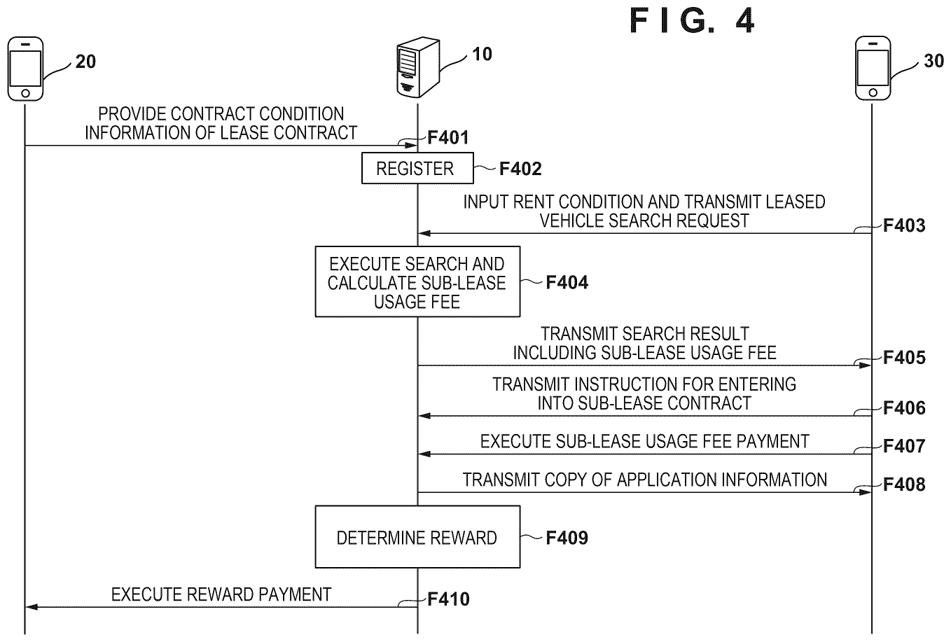

Next, an example of a processing sequence in the information processing system according to an embodiment of the present invention will be described with reference to FIG. 4.

In F401, the communication device 20 provides the server device 10 with contract condition information of a lease contract. The user 21 has entered into a lease contract with a leasing company and has rented the leased vehicle 40. The server device 10 acquires contract condition information when the user 21 has entered into the lease contract. For example, the contract condition information may include a lease usage fee (for example, X yen per month or the like) of the leased vehicle 40, and a contract period (for example, from X-th day of X-year X). The contract condition information may include location information of a parking lot used by the user 21.

In a case where the user 21 directly enters into the lease contract with the leasing company at a store or the like, the contract condition information may be transmitted to the server device 10 via a personal computer or the like of the store. An example in which the communication device 20 provides the server device 10 with the contract condition information of the lease contract may correspond to a case where the user 21 has entered into the lease contract with the leasing company via the Internet.

The communication device 20 may further transmit, to the server device 10 via a dedicated application for making a sub-lease contract, information on a desired date and time of lending within the lease contract period (for example, June 29, 13:00 to 24:00, all day of June 30, or the like), and a delivery place and a delivery method of the leased vehicle at the time of lending. The dedicated application may be provided by a leasing company. In a case where the server device 10 is an information processing apparatus of a leasing company, the server device 10 may provide the application. Another server device may provide the application instead of the server device 10.

In F402, the server device 10 registers the contract condition information of the lease contract received from the communication device 20 in the storage device 102. The server device 10 registers the information of the lending condition (information on the desired date and time of lending, information on the delivery place and delivery method of the leased vehicle at the time of lending, and the like) received from the communication device 20 in the storage device 102. As a result, the server device 10 can hold the information on the contract conditions of the user 21 who has made a lease contract for the leased vehicle 40 and the information on the lending condition of the leased vehicle 40.

In F403, in response to the user 31 of the communication device 30 inputting a rent condition via the dedicated application and searching for a leased vehicle to be rented under the sub-lease contract, the communication device 30 transmits a search request to the server device 10. For example, the rent condition including at least one of a vehicle type, a year of manufacture, a vehicle location range, a date and time when the user wishes to rent under a sub-lease, and period information is input, and a search request based on the rent condition is transmitted to the server device 10. The server device 10 registers and holds in advance contract condition information of lease contracts of a plurality of users and information such as the desired rent date and time and the period, so that the user 31 can search for a desired leased vehicle.

In F404, the server device 10 executes the search and calculates the sub-lease usage fee of each leased vehicle included in the search result on the basis of the lease contract fee paid by the user 21 and the rent condition under the sub-lease desired by the user 31. A method of calculating the sub-lease usage fee will be described later.

In F405, the server device 10 transmits a search result including information on the calculated sub-lease usage fee to the communication device 30.

In F406, the communication device 30 displays the received search result, and receives an instruction to execute the sub-lease contract for a specific leased vehicle among the leased vehicles included in the search result. The search result may include information on a delivery place and a delivery method of the leased vehicle at the time of lending. As a result, it is possible to easily find a leased vehicle with a condition that the user 31 can easily rent.

When receiving the instruction, the communication device 30 transmits the instruction content to the server device 10. For example, an instruction to execute the sub-lease contract may be transmitted to the server device 10 by the user 31 selecting a specific leased vehicle in consideration of the sub-lease usage fee included in the search result and pressing a determination button.

In F407, the communication device 30 executes payment of the sub-lease usage fee. In the present embodiment, the sub-lease usage fee is paid not to the user 21 but to the leasing company. In a case where the server device 10 is an information processing apparatus of a leasing company, payment processing is executed on the server device 10. In a case where the server device 10 is not the information processing apparatus of the leasing company, it can be configured such that payment processing is executed to the leasing company via the server device 10.

The processing of F406 and F407 may be executed as one process. That is, the sub-lease usage fee may be paid simultaneously with the transmission of the sub-lease contract execution instruction. In that case, the payment screen may be displayed before the determination button is pressed to accept input of payment information.

In F408, the server device 10 transmits a copy of the application information of the sub-lease contract (confirmation information of the application content) to the communication device 30. As a result, the user 31 can easily confirm that the leased vehicle for which the sub-lease contract has been made is rented from the user 21 during the application period from the application date and time.

In F409, the server device 10 determines a reward to be given to the user 21 on the basis of the sub-lease usage fee. The reward is a reward for reducing the burden of the lease usage fee of the user 21 by an amount of the sub-lease to another user 31 for a specific period. The reward can be given to the user 21 in a form of reducing (discounting) the lease usage fee in the current month or the next month. Alternatively, the monthly lease usage fee may remain the same and a reward may be paid to the bank account of the user 21. The reward may be paid in the form of electronic money, cryptocurrency, or the like, instead of cash transfer to a bank account. The reward may be paid in the form of points. For example, the point may be a point that can be allocated to the usage fee of the leased vehicle, or may be a point of another company operated by a company different from the leasing company. Details of a method of determining the reward amount will be described later.

In F410, the server device 10 executes payment of a reward to the user 21. The execution timing of the payment of the reward may be a timing at which the user 31 actually rents a leased vehicle from the user 21 under a sub-lease, uses the leased vehicle, and returns the vehicle. As a result, it is possible to prevent trouble such as refund at the time of occurrence of cancellation.

### Processing of Server Device

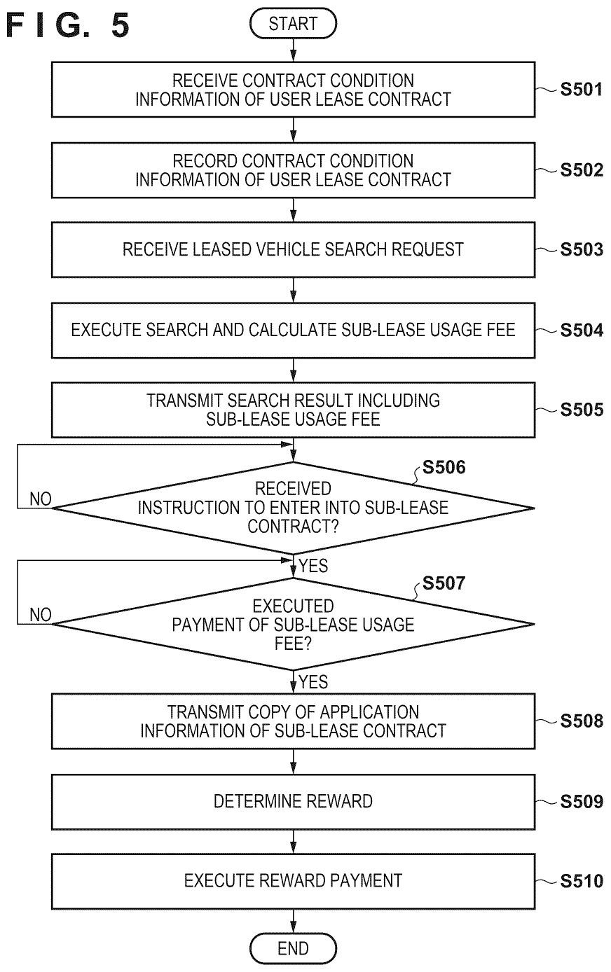

Next, a procedure of processing performed by the server device 10 according to an embodiment of the present invention with respect to the processing sequence illustrated in FIG. 4 will be described with reference to FIG. 5.

In S501, the server device 10 receives, from the communication device 20, the contract condition information of the lease contract, the information of the lending condition of the leased vehicle 40, and the like. The contract condition information may include a lease usage fee (for example, X yen per month or the like) of the leased vehicle 40, and a contract period (for example, from X-th day of X-year X). The information on the lending condition may include information on a lending desired date and time (for example, June 29, 13:00 to 24:00, all day of June 30, or the like) within the lease contract period, and a delivery place and a delivery method of the leased vehicle at the time of lending.

In S502, the server device 10 registers, in the storage device 102, the contract condition information of the lease contract and the information of the lending condition of the leased vehicle 40 received from the communication device 20. In S503, the server device 10 receives, from the communication device 30, a search request for searching for a leased vehicle to be leased under the sub-lease contract.

In S504, the server device 10 executes the search in response to the search request, and calculates the lease usage fee of each leased vehicle included in the search result on the basis of the lease contract fee paid by the user 21 and the rent condition in the sub-lease desired by the user 31. The server device 10 calculates the sub-lease usage fee so that the sub-lease usage fee per unit time paid by the user 31 is higher than the lease usage fee per unit time paid by the user 21. For example, the sub-lease usage fee is calculated such that the sub-lease usage fee paid by the user 31 per unit time is an amount obtained by multiplying the lease usage fee paid by the user 21 per unit time by a predetermined coefficient (>1). The predetermined coefficient can be, for example, 1.5 to 3.0.

For example, assume that the user 31 desires lending for one day. First, the server device 10 calculates the lease usage fee per day by dividing the monthly lease usage fee by the number of days of the desired month of lending. For example, in a case where the lease usage fee is 30,000 yen per month and the number of days of the desired month of lending is 30 days, the lease usage fee per day can be obtained as 30,000 yen/30 days=1,000 yen. The server device 10 may calculate 2,000 yen obtained by multiplying the lease usage fee of 1,000 yen per day paid by the user 21 by a predetermined coefficient (for example, 2.0) as the sub-lease usage fee per day paid by the user 31. In a case where the desired period of lending of the user 31 is two days, 4,000 yen, which is twice the sub-lease usage fee of 2,000 yen per day, can be calculated as the sub-lease usage fee.

The server device 10 may calculate the sub-lease usage fee by further adding an amount corresponding to the fuel fee. The fuel fee is a gasoline fee for a gasoline vehicle, and a charging fee for an electric vehicle. For example, the amount equivalent to the fuel fee may be added to the sub-lease usage fee of 2,000 yen in a case where the desired period of lending of the user 31 is one day calculated as described above. For example, in a case where the user 31 has transmitted the information on the destination in the search request, by calculating the amount of fuel predicted to decrease using the round-trip distance to the destination and the fuel consumption information of the leased vehicle, and multiplying the fuel unit price (X yen/liter) the calculated the amount of fuel to calculate the necessary fuel fee, the result may be used as the amount equivalent to the fuel fee.

Alternatively, in consideration of the possibility of stopover to a stopping point other than the destination, a value obtained by multiplying the calculated value of the fuel fee by a predetermined coefficient (for example, 1.1 to 1.5) may be used as the amount equivalent to the fuel fee. For example, when the amount equivalent to the fuel fee is calculated to be 800 yen, 2,800 yen obtained by adding the amount equivalent to the fuel fee of 800 yen to the calculated sub-lease usage fee of 2,000 yen may be used as the sub-lease usage fee. In a case where the user 31 does not desire to add the fuel fee, the fuel fee may be adjusted when the use period of the sub-lease ends and the leased vehicle 40 is returned to the user 21.

In S505, the server device 10 transmits a search result including information on the sub-lease usage fee calculated in S504 to the communication device 30.

In S506, the server device 10 determines whether an instruction to enter into the sub-lease contract has been received from the communication device 30. The user 31 of the communication device 30 compares the sub-lease usage fee of each leased vehicle in the search results of the plurality of leased vehicles, and selects a specific leased vehicle. Then, in response to the input of the instruction to determine to enter into the sub-lease contract for the selected leased vehicle, the instruction is transmitted from the communication device 30 and received by the server device 10. If the instruction to enter into the sub-lease contract is received, the process proceeds to S507. On the other hand, if the instruction to enter into the sub-lease contract has not been received, the process waits until the instruction is received. In a case where the instruction has not been received for a predetermined time or more, a timeout may occur and the series of processing may be terminated.

In S507, the server device 10 determines whether the sub-lease usage fee has been paid. If the payment has been made, the process proceeds to S508. On the other hand, if the payment has not been made, the process waits. The payment of the sub-lease usage fee may also be automatically performed in response to the instruction to enter into the sub-lease contract. Alternatively, payment may be performed through procedures such as bank transfer and card settlement after an instruction to enter into a sub-lease contract is given.

In S508, the server device 10 transmits a copy of the application information of the sub-lease contract to the communication device 30.

In S509, the server device 10 determines a reward to be given to the user 21 on the basis of the sub-lease usage fee. The reward is a reward for reducing the burden of the lease usage fee of the user 21 by an amount of the sub-lease to another user 31 for a specific period. More specifically, the server device 10 determines the reward on the basis of an amount obtained by subtracting the lease usage fee per unit time paid by the user 21 from the sub-lease usage fee per unit time paid by the user 31. For example, an amount obtained by multiplying an amount smaller than an amount obtained by subtracting the lease usage fee per day paid by the user 21 from the sub-lease usage fee per day paid by the user 31 by the number of use days in the sub-lease can be determined as the reward.

Consider a case where the sub-lease usage fee paid by the user 31 per day is 1,800 yen, and the lease usage fee paid by the user 21 per day is 1,000 yen. In addition, assume that the number of use days is three. In this case, the subtracted amount is 1,800 yen−1,000 yen=800 yen. The amount is multiplied by a predetermined coefficient (for example, 0.5) smaller than 1. In a case where the predetermined coefficient is 0.5, 800 yen×0.5=400 yen. 1,200 yen obtained by multiplying this amount (400 yen) by the number of use days (3 days) is determined as a reward.

In S510, the server device 10 executes payment of a reward to the user 21. The reward can be given to the user 21 by reducing (discounting) the lease usage fee in the current month or the next month. Alternatively, the monthly lease usage fee may remain the same and a reward may be paid to the bank account of the user 21. The reward may be paid in a form of electronic money, cryptocurrency, or the like instead of cash.

### Example of Delivery Method of Leased Vehicle

When the user 31 uses the leased vehicle of the user 21 under the sub-lease contract, the leased vehicle 40 needs to be delivered. In F406 and S505, in a case where the information on the delivery place and the delivery method of the leased vehicle at the time of lending is also presented to the user 31, the information may be described on the copies of the application information transmitted in F408 and S508. The user 31 can achieve the delivery by confirming the information. For example, the information of the parking position (location) of the leased vehicle 40 and the key transfer method (for example, the key being stored in a key box in a parking lot, a personal identification number for unlocking, and the like) may be notified. The user 21 and the user 31 may directly give and receive keys.

As described above, in the present embodiment, the sub-lease usage fee of the leased vehicle is calculated on the basis of the information on the lease usage fee of the user who has made a lease contract for the leased vehicle and the information on the rent condition of another user who has made a sub-lease contract with the user and rents the leased vehicle. Then, a reward to the user who has made the lease contract for the leased vehicle is determined on the basis of the calculated sub-lease usage fee.

As a result, the lease contractor of the leased vehicle can easily lend the leased vehicle to the sub-lease contractor. Since a reward is given for the lending, it is possible to encourage the lease contractor to actively lend the leased vehicle to another person. Since the more the lease contractor lends, the more the reward can be received, the burden of the lease usage fee can be reduced. Therefore, the lease contractor can be expected to maintain a long-term lease contract. Since the financial burden can be reduced, an increase in the number of users who newly make a lease contract for a leased vehicle can also be expected. As a result, it is possible to promote the use of the leased vehicle and the expansion of the lease market.

### Modification

In the above-described embodiment, the sub-lease contract concluded between the users, the calculation of the sub-lease usage fee, and the determination of the reward have been described. In the present modification, information collection on the leasing company side will be described.

As described with reference to FIG. 3B, the leased vehicle 40 includes the in-vehicle camera 406. The in-vehicle camera 406 can image an occupant seated on a driver's seat of the leased vehicle 40. The server device 10 may receive, from the leased vehicle 40, an occupant image obtained by imaging an occupant seated on the driver's seat of the leased vehicle 40. Then, it may be evaluated whether the driver of the leased vehicle 40 is the user 21 on the basis of the received occupant image. As described above, whether the lease contractor (user 21) of the leased vehicle 40 is driving or whether another user such as the sub-lease contractor (user 31) is driving is evaluated from the captured image of the in-vehicle camera 406. As a result, it is possible to clarify the location of responsibility when an accident or the like occurs, and it is possible to prevent occurrence of unnecessary trouble.

As described with reference to FIG. 3B, the leased vehicle 40 includes the vehicle exterior camera 407. The vehicle exterior camera 407 is, for example, a drive recorder, and can acquire driving record information. The leased vehicle 40 may be further capable of acquiring information on a driving record of a driving operation (sudden steering, sudden braking, sudden acceleration, or the like) of the vehicle.

The server device 10 may receive a driving record of the leased vehicle 40 from the leased vehicle 40. The driving record may include data of a drive recorder installed in the leased vehicle 40. As a result, it is possible to clarify the location of responsibility when an accident or the like occurs, and it is possible to prevent occurrence of unnecessary trouble.

In a case where the user 31 is a student, the server device 10 may receive the student identification card information of the user 31 via the communication device 30. The student identification card information may be, for example, a copy image of the student identification card. When the student identification card information is received, the server device 10 may calculate the sub-lease usage fee by applying the student discount. As a result, it is possible to promote the use experience of the leased vehicle even for a group (student) who has a financial difficulty in directly entering into the lease contract to the leased vehicle. This also leads to an increase in prospective customers who will make a lease contract for a leased vehicle in the future.

In the above-described embodiment, an example has been described in which the user 31 who desires to use the sub-lease of the leased vehicle selects an appropriate leased vehicle by search and enters into the sub-lease contract, but the present invention is not limited to this example. For example, assume that the user 21 is familiar with the user 31. In that case, the user 31 of the communication device 30 may input information on the user 21 (for example, the ID information of the user 21, the number information of the leased vehicle 40, and the like) to rent the leased vehicle 40 of the user 21 and transmit the information to the server device 10. Then, it may be configured such that the user 31 of the communication device 30 receives the presentation of the sub-lease usage fee for the leased vehicle 40 of the user 21 in the same manner as the processing described in the above-described embodiment. As a result, time and effort for searching can be saved.

### SUMMARY OF EMBODIMENTS

1. The information processing apparatus (10) according to the above embodiments is an information processing apparatus comprising:
a holding unit (102) configured to hold information on a lease usage fee of a first user (21) who has a lease contract for a leased vehicle (40);
a reception unit (103) configured to receive information on a rent condition of a second user who is to have a sub-lease contract with the first user and rent the leased vehicle;
a calculation unit (101) configured to calculate a sub-lease usage fee of the leased vehicle based on the information on the lease usage fee and the information on the rent condition; and
a determination unit (101) configured to determine a reward to the first user based on the sub-lease usage fee.

As a result, the lease contractor of the leased vehicle can easily lend the leased vehicle to the sub-lease contractor. Since a reward is given for the lending, it is possible to encourage the lease contractor to actively lend the leased vehicle to another person. Since the more the lease contractor lends, the more the reward can be received, the burden of the lease usage fee can be reduced. Therefore, the lease contractor can be expected to maintain a long-term lease contract. Since the financial burden can be reduced, an increase in the number of users who newly make a lease contract for a leased vehicle can also be expected. As a result, it is possible to promote the use of the leased vehicle and the expansion of the lease market.

2. In the information processing apparatus (10) according to the above embodiments, the calculation unit calculates the sub-lease usage fee so that a sub-lease usage fee per unit time paid by the second user is higher than a lease usage fee per unit time paid by the first user.

As a result, it is possible to calculate an appropriate sub-lease usage fee in a case where the leased vehicle is sub-leased.

3. In the information processing apparatus (10) according to the above embodiments, the calculation unit further adds, to the sub-lease usage fee, an amount equivalent to a fuel fee required when the leased vehicle is used in sub-lease.

As a result, it is possible to save time and effort for charging the fuel fee later.

4. In the information processing apparatus (10) according to the above embodiments, the determination unit determines the reward based on an amount obtained by subtracting a lease usage fee per unit time paid by the first user from a sub-lease usage fee per unit time paid by the second user.

As a result, it is possible to determine an appropriate reward to be paid to the lease contractor when the leased vehicle is sub-leased.

5. In the information processing apparatus (10) according to the above embodiments, the determination unit determines, as the reward, an amount obtained by multiplying an amount smaller than an amount obtained by subtracting a lease usage fee per day paid by the first user from a sub-lease usage fee per day paid by the second user by the number of use days in sub-lease.

As a result, it is possible to determine an appropriate reward to be paid to the lease contractor when the leased vehicle is sub-leased.

6. The information processing apparatus (10) according to the above embodiments, further comprising a provision unit configured to provide the reward to the first user.

As a result, when the leased vehicle is sub-leased, the lease contractor can obtain a reward.

7. In the information processing apparatus (10) according to the above embodiments, the provision unit provides the reward to the first user by reducing the lease usage fee.

As a result, the financial burden of the lease usage fee can be reduced.

8. In the information processing apparatus (10) according to the above embodiments, the provision unit provides the reward to the first user in a form of cash, electronic money, or cryptocurrency.

As a result, the financial burden of the lease usage fee can be reduced. Since the obtained reward can be used for purchase of various products and services, the degree of freedom increases.

9. The information processing apparatus (10) according to the above embodiments, further comprising:
an image reception unit configured to receive an occupant image obtained by imaging an occupant seated on a driver's seat of the leased vehicle from the leased vehicle; and
an evaluation unit configured to evaluate whether a driver of the leased vehicle is the first user based on the occupant image.

As a result, it is possible to clarify the location of responsibility when an accident or the like occurs, and it is possible to prevent occurrence of unnecessary trouble.

10. The information processing apparatus (10) according to the above embodiments, further comprising a driving record reception unit configured to receive a driving record of the leased vehicle from the leased vehicle.

As a result, it is possible to clarify the location of responsibility when an accident or the like occurs, and it is possible to prevent occurrence of unnecessary trouble.

11. In the information processing apparatus (10) according to the above embodiments, the driving record includes data of a drive recorder installed in the leased vehicle.

As a result, when an accident or the like occurs, it is possible to confirm the situation at the time with a video.

12. The information processing apparatus (10) according to the above embodiments, further comprising an information reception unit configured to receive student identification card information of the second user,
wherein the calculation unit calculates the sub-lease usage fee by applying a student discount in a case where the student identification card information is received.

As a result, it is possible to promote the use experience of the leased vehicle even for a group (student) who has a financial difficulty in directly entering into the lease contract to the leased vehicle. This also leads to an increase in prospective customers who will make a lease contract for a leased vehicle in the future.

13. The communication device (30) according to the above embodiments is a communication device that communicates with an information processing apparatus (10), the communication device comprising:
an acceptance unit (305) configured to accept an input of a rent condition from a second user (31) who desires to make a sub-lease contract with a first user (21) who has a lease contract for a leased vehicle (40) and rent the leased vehicle;
a transmission unit (303) configured to transmit information on the rent condition to the information processing apparatus; and
a reception unit (303) configured to receive information on a sub-lease usage fee of the leased vehicle, the sub-lease usage fee being calculated by the information processing apparatus based on information on a lease usage fee of the leased vehicle and information on the rent condition.

As a result, it is easy for the user who desires the sub-lease of the leased vehicle to determine whether to actually rent the leased vehicle by checking the sub-lease usage fee.

14. The control method of an information processing apparatus (10) according to the above embodiments is a control method of an information processing apparatus comprising a holding unit (102) configured to hold information on a lease usage fee of a first user (21) who has a lease contract for a leased vehicle (40), the control method comprising:
receiving (F403, S503) information on a rent condition of a second user (31) who is to have a sub-lease contract with the first user and rent the leased vehicle;
calculating (F404, S504) a sub-lease usage fee of the leased vehicle based on the information on the lease usage fee and the information on the rent condition; and
determining (F409, S509) a reward to the first user based on the sub-lease usage fee.

As a result, the lease contractor of the leased vehicle can easily lend the leased vehicle to the sub-lease contractor. Since a reward is given for the lending, it is possible to encourage the lease contractor to actively lend the leased vehicle to another person. Since the more the lease contractor lends, the more the reward can be received, the burden of the lease usage fee can be reduced. Therefore, the lease contractor can be expected to maintain a long-term lease contract. Since the financial burden can be reduced, an increase in the number of users who newly make a lease contract for a leased vehicle can also be expected. As a result, it is possible to promote the use of the leased vehicle and the expansion of the lease market.

15. The control method of a communication device (30) according to the above embodiments is a control method of a communication device that communicates with an information processing apparatus (10), the control method comprising:
accepting (F403) an input of a rent condition from a second user (31) who desires to make a sub-lease contract with a first user (21) who has a lease contract for a leased vehicle (40) and rent the leased vehicle;
transmitting (F404) information on the rent condition to the information processing apparatus; and
receiving (F405) information on a sub-lease usage fee of the leased vehicle, the sub-lease usage fee being calculated by the information processing apparatus based on information on a lease usage fee of the leased vehicle and information on the rent condition.

As a result, it is easy for the user who desires the sub-lease of the leased vehicle to determine whether to actually rent the leased vehicle by checking the sub-lease usage fee.

16. The program according to the above embodiments is
a program for causing a computer to execute the control method described in the above embodiment.

As a result, the control method of the information processing apparatus or the control method of the communication device can be achieved as a program.

17. The storage medium according to the above embodiments is
a storage medium storing a program for causing a computer to execute the control method described in the above embodiment.

As a result, the control method of the information processing apparatus or the control method of the communication device can be achieved as a storage medium.

### Other Embodiments

In addition, a program for achieving one or more functions that have been described in each of the embodiments is supplied to a system or an apparatus through a network or via a storage medium, and one or more processors on a computer of the system or the apparatus are capable of reading and executing the program. The present invention can also be achieved by such an aspect.

According to the present invention, it is possible to promote use of a leased vehicle.

The invention is not limited to the foregoing embodiments, and various variations/changes are possible within the spirit of the invention.

According to the present invention, it is possible to promote the use of the leased vehicle.

What is claimed is:

1. An information processing apparatus comprising:
a holding unit configured to hold information on a lease usage fee of a first user who has a lease contract for a leased vehicle;
a reception unit configured to receive information on a rent condition of a second user who is to have a sub-lease contract with the first user and rent the leased vehicle;
a calculation unit configured to calculate a sub-lease usage fee of the leased vehicle based on the information on the lease usage fee and the information on the rent condition; and
a determination unit configured to determine a reward to the first user based on the sub-lease usage fee.

2. The information processing apparatus according to claim 1, wherein the calculation unit calculates the sub-lease usage fee so that a sub-lease usage fee per unit time paid by the second user is higher than a lease usage fee per unit time paid by the first user.

3. The information processing apparatus according to claim 2, wherein the calculation unit further adds, to the sub-lease usage fee, an amount equivalent to a fuel fee required when the leased vehicle is used in sub-lease.

4. The information processing apparatus according to claim 1, wherein the determination unit determines the reward based on an amount obtained by subtracting a lease usage fee per unit time paid by the first user from a sub-lease usage fee per unit time paid by the second user.

5. The information processing apparatus according to claim 1, wherein the determination unit determines, as the reward, an amount obtained by multiplying an amount smaller than an amount obtained by subtracting a lease usage fee per day paid by the first user from a sub-lease usage fee per day paid by the second user by the number of use days in sub-lease.

6. The information processing apparatus according to claim 1, further comprising a provision unit configured to provide the reward to the first user.

7. The information processing apparatus according to claim 6, wherein the provision unit provides the reward to the first user by reducing the lease usage fee.

8. The information processing apparatus according to claim 6, wherein the provision unit provides the reward to the first user in a form of cash, electronic money, or cryptocurrency.

9. The information processing apparatus according to claim 1, further comprising:
an image reception unit configured to receive an occupant image obtained by imaging an occupant seated on a driver's seat of the leased vehicle from the leased vehicle; and
an evaluation unit configured to evaluate whether a driver of the leased vehicle is the first user based on the occupant image.

10. The information processing apparatus according to claim 1, further comprising a driving record reception unit configured to receive a driving record of the leased vehicle from the leased vehicle.

11. The information processing apparatus according to claim 10, wherein the driving record includes data of a drive recorder installed in the leased vehicle.

12. The information processing apparatus according to claim 1, further comprising an information reception unit configured to receive student identification card information of the second user,
wherein the calculation unit calculates the sub-lease usage fee by applying a student discount in a case where the student identification card information is received.

13. A communication device that communicates with an information processing apparatus, the communication device comprising:
an acceptance unit configured to accept an input of a rent condition from a second user who desires to make a sub-lease contract with a first user who has a lease contract for a leased vehicle and rent the leased vehicle;
a transmission unit configured to transmit information on the rent condition to the information processing apparatus; and
a reception unit configured to receive information on a sub-lease usage fee of the leased vehicle, the sub-lease usage fee being calculated by the information processing apparatus based on information on a lease usage fee of the leased vehicle and information on the rent condition.

14. A control method of an information processing apparatus comprising a holding unit configured to hold information on a lease usage fee of a first user who has a lease contract for a leased vehicle, the control method comprising:
receiving information on a rent condition of a second user who is to have a sub-lease contract with the first user and rent the leased vehicle;
calculating a sub-lease usage fee of the leased vehicle based on the information on the lease usage fee and the information on the rent condition; and
determining a reward to the first user based on the sub-lease usage fee.
